(19) United States
(12) Patent Application Publication
(10) Pub. No.: US 2019/0061517 A1
(43) Pub. Date: Feb. 28, 2019

(54) OPENING AND CLOSING DEVICE FOR FUEL TANK

(71) Applicant: TOYODA GOSEI CO., LTD., Kiyosu-shi (JP)

(72) Inventor: Hiroyuki HAGANO, Kiyosu-shi (JP)

(21) Appl. No.: 16/106,920

(22) Filed: Aug. 21, 2018

(30) Foreign Application Priority Data
Aug. 29, 2017 (JP) 2017-163902

(51) Int. Cl. B60K 15/04

(52) U.S. Cl. CPC B60K 15/0406; B60K 2015/03523

(57) ABSTRACT

In an opening and closing device (100) for a fuel tank, a path forming part (20) forms a fuel path (100P) along which supplied liquid fuel is guided to the fuel tank. A first valve mechanism (10) arranged at the path forming part (20) opens and closes a filling opening (104). A second valve mechanism (30) opens and closes an insertion path (100Pn) for a fuel nozzle (FN) at the end of the insertion path (100Pn) in the most upstream area of the fuel path (100P). In a non-filling situation in which the first valve mechanism (10) closes the filling opening (104), passage of air between an insertion path communication hole (51) and an outside air passage hole (53) is encouraged. In a filling situation in which the fuel nozzle (FN) makes the first valve mechanism (10) open the filling opening (104), passage of air between the insertion path communication hole (51) and the outside air passage hole (53) is interrupted. Therefor the opening and closing device (100) for the fuel tank prevents or reduces discharge of fuel in a fuel filling period while ensuring air permeability in a non-filling period.

### CROSS-REFERENCE TO RELATED APPLICATION

The present application claims priority from Japanese application P2017-163902 filed on Aug. 29, 2017, the content of which is hereby incorporated by reference into this application.

### BACKGROUND

### 1. Field

The present disclosure relates to an opening and closing device for a fuel tank.

### 2. Related Art

In an opening and closing device for a fuel tank conventionally known, a fuel path is opened in response to insertion of a filling nozzle in a period of supply of liquid fuel (hereinafter called a fuel filling period) into a fuel tank in a vehicle. In a non-filling period in which the liquid fuel is not supplied, the fuel path is closed. In such an opening and closing device, a valve element itself closing the fuel path in the non-filling period or the interior of the valve element is required to have a tank inner pressure adjusting part for ventilation. However, forming a simple ventilation path adversely causes a risk of entry of water such as rainwater into an insertion path for insertion of the filling nozzle. A drainage path configuration responsive to this issue is suggested in Japanese Patent Application Publication No. 2014-69618, for example. This drainage path configuration includes a drainage path connecting the insertion path and the outside and this drainage path is configured as a labyrinth, thereby preventing entry of dust, etc. while ensuring air permeability in the non-filling period.

A demand for minimizing discharge of fuel to the outside in the fuel filling period has newly been made in recent years. In the opening and closing device described in the foregoing patent document, the drainage path is used for discharge of fuel. In this usage, if fuel overflows into the insertion path in the fuel filling period, it becomes hard to prevent the overflowing fuel from being discharged to the outside. This has caused a demand for an opening and closing device capable of preventing or reducing discharge of fuel in the fuel filling period while ensuring air permeability in the non-filling period.

### SUMMARY

The present disclosure has been made to solve at least some of the foregoing problems and is feasible in the following aspects.

(1) According to one aspect of the present disclosure, an opening and closing device for a fuel tank is provided. The opening and closing device for a fuel tank comprises: a path forming part that forms a fuel path along which supplied liquid fuel is guided to the fuel tank; a first valve mechanism arranged at the path forming part for opening and closing a filling opening of the fuel path; a second valve mechanism arranged at the path forming part to be closer to a fuel tank side than the first valve mechanism, the second valve mechanism opening and closing an insertion path for a fuel nozzle at the end of the insertion path in the most upstream area of the fuel path using an opening and closing member; and a ventilation mechanism that encourages passage of outside air into the insertion path. The path forming part includes: an insertion path forming part that defines the insertion path in the most upstream area of the fuel path, and forms an insertion path communication hole communicating with the insertion path on an extension line of a direction in which the first valve mechanism moves during operation of opening the first valve mechanism; and a surrounding part that surrounds the insertion path forming part from outside with a gap left between the surrounding part and the insertion path forming part, and includes an outside air passage hole formed to make the gap communicate with outside air. In a non-filling situation in which the first valve mechanism closes the filling opening, the ventilation mechanism encourages passage of air between the insertion path communication hole and the outside air passage hole through the gap. In a filling situation in which the fuel nozzle makes the first valve mechanism open the filling opening, the ventilation mechanism interrupts passage of air between the insertion path communication hole and the outside air passage hole.

In the opening and closing device for a fuel tank of this aspect, in the non-filling situation in which the first valve mechanism closes the filling opening, passage of air between the insertion path communication hole and the outside air passage hole is encouraged to ensure the performance of passing air into the insertion path. In the opening and closing device for a fuel tank of this aspect, in the filling situation in which the fuel nozzle makes the first valve mechanism open the filling opening, passage of air between the insertion path communication hole and the outside air passage hole is interrupted. Further, in response to insertion of the filling nozzle, the second valve mechanism opens the insertion path at the end of the insertion path. In the filling situation, liquid fuel supplied from the filling nozzle may overflow into the insertion path. In this state, passage of air between the insertion path communication hole and the outside air passage hole is interrupted, so that the overflowing liquid fuel once stays in the insertion path and then flows from the insertion path into the fuel path. In this way, the opening and closing device for a fuel tank of this aspect is allowed to prevent discharge of the overflowing liquid fuel to the outside through the insertion path communication hole in the fuel filling situation, or reduce a degree of discharge of the liquid fluid.

(2) In the opening and closing device for a fuel tank of the foregoing aspect, the second valve mechanism may include a pressure adjusting mechanism provided at the opening and closing member. In the non-filling situation, if pressure in the fuel path downstream from the opening and closing member is higher than pressure in the insertion path upstream from the opening and closing member, the pressure adjusting mechanism may encourage passage of air from the fuel path downstream from the opening and closing member into the insertion path. This allows reduction in pressure in the fuel path downstream from the opening and closing member. Further, gas of liquid fuel having flowed from the fuel path downstream from the opening and closing member into the insertion path is allowed to be emitted to outside air through the insertion path communication hole.

(3) In the opening and closing device for a fuel tank of the foregoing aspect, in the non-filling situation, if pressure in the fuel path downstream from the opening and closing member becomes lower than pressure in the insertion path upstream from the opening and closing member, the second valve mechanism may drive the opening and closing member so as to open the insertion path. This makes it possible to resolve or reduce the likelihood of generation of what is called a negative pressure in the fuel path downstream from the opening and closing member, eventually, in the fuel tank to which this path is connected in the non-filling situation.

(4) In the opening and closing device for a fuel tank of the foregoing aspect, the ventilation mechanism may include an on-off valve to be driven in conjunction with operation for opening and closing the filling opening by the first valve mechanism, and the on-off valve may close the insertion path communication hole in the filling situation, and open the insertion path communication hole in the non-filling situation. By doing so, by closing the insertion path communication hole using the on-off valve working in conjunction with the operation for opening and closing the filling opening by the first valve mechanism, discharge of overflowing liquid fuel to the outside in the filling situation is reduced with higher accuracy.

(5) in the opening and closing device for a fuel tank of the foregoing aspect, the on-off valve may include an elastic deflection part, and may open and close the insertion path communication hole with the elastic deflection part. By doing so, the deformation of the elastic deflection part is used for absorbing variations in the position of the on-off valve to allow the insertion path communication hole to he closed with higher accuracy

(6) In the opening and closing device for a fuel tank of the foregoing aspect, while the path forming part is mounted in a filling room, the insertion path communication hole may be located above the outside air passage hole in the vertical direction. This increases a gap from the second valve mechanism to the insertion path communication hole. Thus, even if liquid fuel overflows in large quantities into the insertion path in the fuel filling period, discharge of the overflowing liquid fuel to the outside is still reduced with higher accuracy.

(7) In the opening and closing device for a fuel tank of the foregoing aspect, the outside air passage hole may be located at a position shifted from the insertion path communication hole around an axis in the insertion path. This allows the gap between the insertion path forming part and the surrounding part for encouraging passage of air between the insertion path communication hole and the outside air passage hole to be formed into a bent path or a labyrinth configuration. This makes it possible to reduce mixture of impurities such as dust or dirt during passage of air into the insertion path in the non-filling situation.

(8) In the opening and closing device for a fuel tank of the foregoing aspect, the insertion path forming part may form a liquid-tight region between the insertion path forming part and the surrounding part, the liquid-tight region surrounding the opening and closing member of the second valve mechanism in a liquid-tight manner from a side of the insertion path. The surrounding part may include the outside air passage hole communicating with the liquid-tight region, and an opening part through which the liquid-tight region is opened to outside air at a low-level position in the vertical direction while the path forming part is mounted in a filling room. This makes it possible to discharge water having entered through the outside air passage hole by causing the water to stay in the liquid-tight region, and then discharging the water through the opening part to the outside.

(9) In the opening and closing device for a fuel tank of the foregoing aspect, the outside air passage hole may have a smaller diameter than the insertion path communication hole, and may be formed at the surrounding part along the axis of the insertion path communication hole. The ventilation mechanism may include an on-off valve to be driven in conjunction with operation for opening and closing the filling opening by the first valve mechanism and having a size that allows the on-off valve to pass through the insertion path communication hole. In the filling situation, the on-off valve may pass through the insertion path communication hole to close the outside air passage hole. In the non-filling situation, the on-off valve may open the insertion path communication hole and the outside air passage hole. By doing so, by closing the outside air passage hole using the on-off valve working in conjunction with the operation for opening and closing the filling opening using the first valve mechanism, discharge of overflowing liquid fuel to the outside in the filling situation is reduced with higher accuracy.

(10) In the opening and closing device for a fuel tank of the foregoing aspect, the on-off valve of the ventilation mechanism may be fitted as a part of at least one of the first valve mechanism and the insertion path forming part. This allows the insertion path communication hole or the outside air passage hole to be opened and closed using the fitted on-off valve.

(11) In the opening and closing device for a fuel tank of the foregoing aspect, the on-off valve of the ventilation mechanism may be fitted as a part of the first valve mechanism by being held by a valve support member. This allows the insertion path communication hole or the outside air passage hole to be opened and closed using the on-off valve fitted as a part of the first valve mechanism.

(12) In the opening and closing device for a fuel tank of the foregoing aspect, the valve support member may have elasticity. By doing so, the deflection of the valve support member becomes available for ensuring a closed state of the insertion path communication hole or the outside air passage hole produced by the on-off valve fitted as a part of the first valve mechanism. This increases part accuracy or a degree of freedom in assembly clearance of each part.

(13) In the opening and closing device for a fuel tank of the foregoing aspect, the on-off valve of the ventilation mechanism may be fitted as a part of the insertion path forming part by being held by a valve support member. This allows the insertion path communication hole or the outside air passage hole to be opened and closed using the on-off valve fitted as a part of the insertion path forming part.

(14) In the opening and closing device for a fuel tank of the foregoing aspect, the valve support member may have elasticity. By doing so, the deflection of the valve support member becomes available for ensuring a closed state of the insertion path communication hole or the outside air passage hole produced by the on-off valve fitted as a part of the insertion path forming part. This increases part accuracy or a degree of freedom in assembly clearance of a part.

The present disclosure is feasible in various aspects other than the opening and closing device for a fuel tank. These aspect include a filling system including the opening and closing device for a fuel tank, a vehicle equipped with the opening and closing device for a fuel tank, and a method of manufacturing the opening and closing device for a fuel tank, for example.

### BRIEF DESCRIPTION OF THE DRAWINGS

FIG. 1 is an explanatory view showing a filling system in outline including an opening and closing device for a fuel tank according to an embodiment;

FIG. 2 is a perspective view briefly showing a filler neck functioning as an opening and closing device for a fuel tank according to a first embodiment;

FIG. 3 is an explanatory view showing a principal part of the filler neck in a cross section taken along bent lines 3-3 in FIG. 2;

FIG. 4 is an explanatory view showing a state of adjusting a positive pressure using a pressure adjusting mechanism of a second valve mechanism;

FIG. 5 is an explanatory view showing a state of adjusting a negative pressure using the second valve mechanism;

FIG. 6 is an explanatory view briefly showing fitting of an on-off valve;

FIG. 7 is an explanatory view showing a state in which a ventilation mechanism closes an insertion path communication hole in a fuel filling period;

FIG. 8 is an explanatory view showing a principal part of a filler neck in a cross section according to a second embodiment taken along lines simulating the bent lines 3-3 in FIG. 2;

FIG. 9 is an explanatory view showing a state in which a ventilation mechanism of the filler neck according to the second embodiment closes an outside air passage hole in the fuel filling period;

FIG. 10 is an explanatory view showing a principal part of a filler neck in a cross section according to a third embodiment taken along lines simulating the bent lines 3-3 in FIG. 2;

FIG. 11 is an explanatory view showing a state in which a ventilation mechanism of the filler neck according to the third embodiment closes the insertion path communication hole in the fuel filling period;

FIG. 12 is an explanatory view showing a principal part of a filler neck in a cross section according to a fourth embodiment taken along lines simulating the bent lines 3-3 in FIG. 2;

FIG. 13 is an explanatory view showing a state in which a ventilation mechanism of the filler neck according to the fourth embodiment closes the insertion path communication hole in the fuel filling period;

FIG. 14 is an explanatory view showing a principal part of a filler neck in a cross section according to a fifth embodiment taken along lines simulating the bent lines 3-3 in FIG. 2;

FIG. 15 is an explanatory view showing a state in which a ventilation mechanism of the filler neck according to the fifth embodiment closes the insertion path communication hole in the fuel filling period; and

FIG. 16 is an explanatory view showing a principal part of a filler neck in a cross section according to a sixth embodiment taken along lines simulating the bent lines 3-3 in FIG. 2.

### DESCRIPTION OF THE EMBODIMENTS

### A. First Embodiment

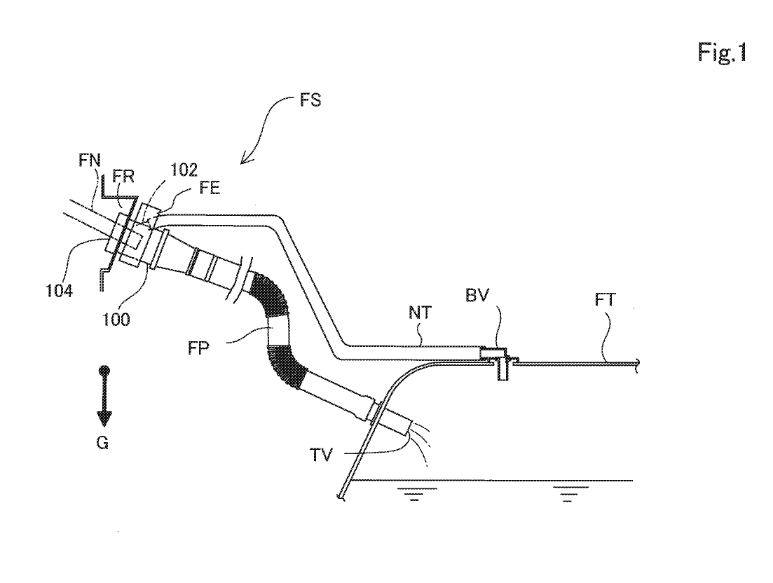

FIG. 1 is an explanatory view showing a filling system FS in outline including an opening and closing device for a fuel tank according to an embodiment. The filling system FS guides fuel supplied from a filling nozzle FN to a fuel tank FT in a vehicle. An arrow G indicating the vertical direction is illustrated in FIG. 1 and subsequent drawings. The filling system FS includes a filler neck 100, a fuel vapor port 102, a filler pipe FP, a check valve TV, a fuel vapor tube NT, a gas emission valve BV, and a fitting member FE. The filler neck 100 is fixed by the fitting member FE to a filling room FR in a vehicle, and accepts insertion of the filling nozzle FN into a filling opening 104. Instead of the illustrated fitting member FE, a substrate like a circular disk with a center circular hole for insertion of a part of the filler neck 100 may be used for mounting the filler neck 100 on the filling room FR.

The filler neck 100 is connected to the fuel tank FT through the filler pipe FP and the fuel vapor tube NT. The filler neck 100 guides liquid fuel such as gasoline from the filling nozzle FN inserted into the filling opening 104 to the fuel tank FT connected to the filler neck 100 through the filler pipe FP. The filler pipe FP is a resin tube having bellows structures formed at two locations, for example. The filler pipe FP expands and contracts, and is bendable in a certain range. The filler pipe FP is connected to the fuel tank FT through the check valve TV. Fuel ejected from the filling nozzle FN inserted into the filling opening 104 passes through a fuel path described later formed by the filler neck 100, passes through the filler pipe FP, and is then guided to the fuel tank FT through the check valve TV. The check valve TV prevents backflow of fuel from the fuel tank FT into the filler pipe FP.

The fuel vapor tube NT has one end connected to the fuel tank FT through the gas emission valve BV, and an opposite end connected to the fuel vapor port 102 projecting from the filler neck 100. The gas emission valve BV functions as a joint for connecting the fuel vapor tube NT to the fuel tank FT. Air inside the tank containing fuel vapor flows from the gas emission valve BV into the fuel vapor tube NT. In a period of supplying fuel from the filling nozzle FN, the fuel vapor passes through the filler pipe FP and is guided to the fuel tank FT together with the supplied fuel. The filler neck 100 will be described in detail below.

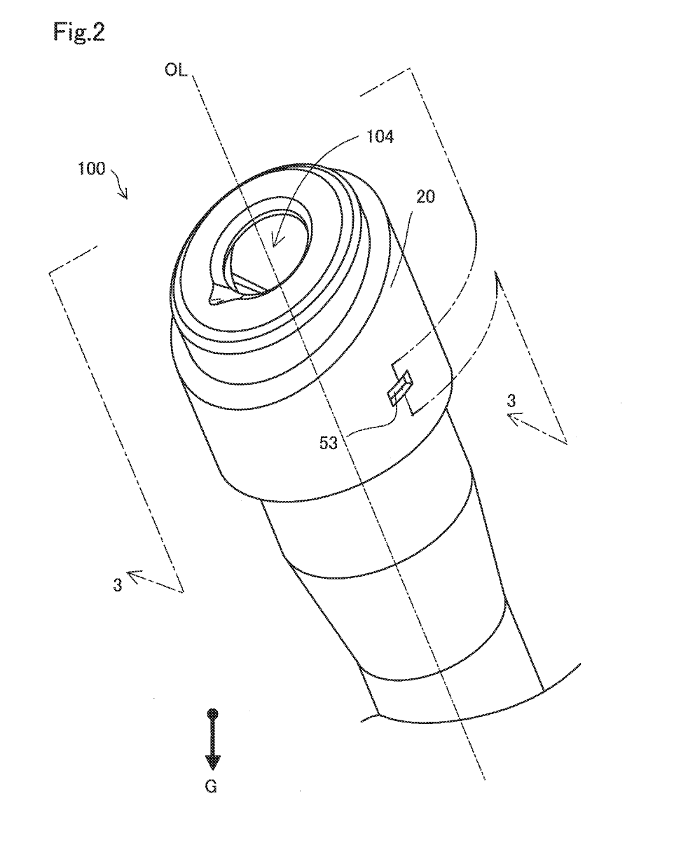

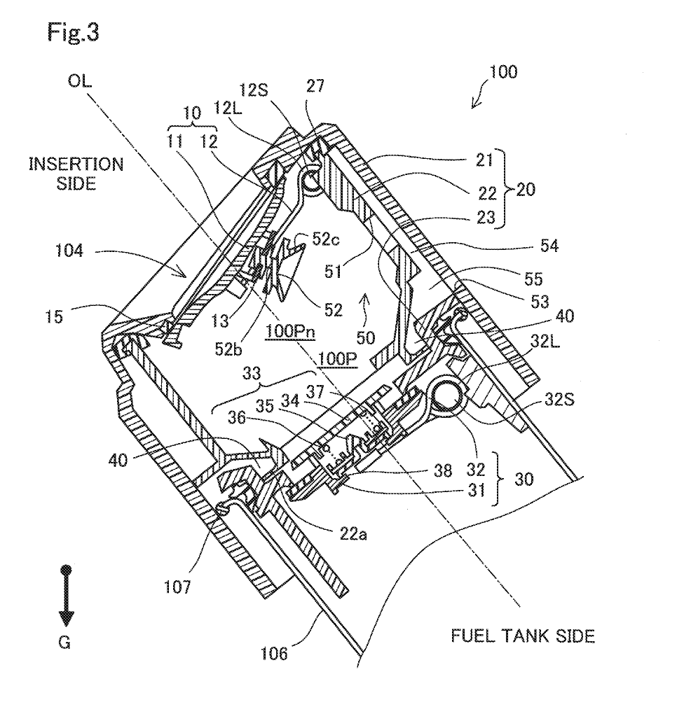

FIG. 2 is a perspective view briefly showing the filler neck 100 functioning as an opening and closing device for a fuel tank according to a first embodiment. FIG. 3 is an explanatory view showing a principal part of the filler neck 100 in a cross section taken along bent lines 3-3 in FIG. 2. In the following description, a place at a shorter distance to the fuel tank than a distance to the filling opening 104 is called a “fuel tank side,” as appropriate, Further, a place at a shorter distance to the filling opening 104 than a distance to the fuel tank is called an “insertion side,” as appropriate. In FIG. 3, to show the constituting parts explicitly, each part is shown in a cross-sectional end view appropriately.

As shown in FIG. 3, the filler neck 100 includes a path forming part 20 that forms a fuel path 100P, a first valve mechanism 10 as a valve mechanism for opening and closing the filling opening 104, a second valve mechanism 30 as a valve mechanism for opening and closing an insertion path 100Pn at a position downstream from the first valve mechanism 10, and a ventilation mechanism 50. The path forming part 20 has a cylindrical shape. The path forming part 20 includes an outer body 21 that forms the filling opening 104, an inner body 22 that defines the most upstream area of the fuel path 100P as the insertion path 100Pn for the filling nozzle FN, and an under body 23 to which the second valve mechanism 30 is mounted on the fuel tank side. The under body 23 is mounted in a liquid-tight manner on an upstream pipe 106 of the filler pipe FP (see FIG. 1) with intervention of a seal member 107. The seal member 107 may be omitted with the intension of opening a liquid-tight region 40 described later to outside air. The fuel path 100P formed using the path forming part 20 having the foregoing body configuration is used for guiding supplied liquid fuel along an axis OL to the fuel tank FT (see FIG. 1). Each of the foregoing bodies is made of a resin material having excellent resistance to fuel permeability such as polyamide (PA) such as nylon, ethylene-vinylalcohol copolymer (EVOH), polyacetal (POM), polybutylene terephthalate (PBT), polyphenylene sulfide (PPS), or liquid crystalline polyester (LCP), for example, to reduce fuel permeation. The outer body 21 and the inner body 22 correspond to a surrounding part and an insertion path forming part of the present disclosure respectively

The inner body 22 includes a thin seal piece 22a having an annular shape formed at the lower end of the inner body 22. The seal piece 22a is fitted to the under body 23 to form the liquid-tight region 40 between the inner body 22 and the outer body 21. The liquid-tight region 40 surrounds a fuel tank side opening and closing member 31 of the second valve mechanism 30 described later in a liquid-tight manner from a side of the insertion path 100Pn. An outside air passage hole 53 formed at the outer body 21 communicates with the liquid-tight region 40 through a communication part 55. While the filler neck 100 is mounted in the filling room FR (see FIG. 1), the liquid-tight region 40 is opened to outside air through the outside air passage hole 53. The inner body 22 is mounted on the outer body 21 with intervention of a packing material 27 formed into an annular shape and made of oil-resistant rubber such as nitrile rubber, butyl rubber, silicone rubber, or fluoro-rubber, for example.

The first valve mechanism 10 is arranged at the outer body 21 of the path forming part 20, and opens and closes the filling opening 104 of the fuel path 100P. Specifically, the first valve mechanism 10 opens the filling opening 104 in response to insertion of the filling nozzle FN (see FIG. 1) into the filling opening 104. When the filling nozzle FN is not inserted, the first valve mechanism 10 closes the filling opening 104. The first valve mechanism 10 includes an insertion side opening and closing member 11 as a valve element for opening and closing the filling opening 104, and an insertion side spring 12 fixed to the path forming part 20 and biasing the insertion side opening and closing member 11 in a direction of closing the insertion side opening and closing member 11. The insertion side opening and closing member 11 is formed into a circular disk shape with a center recessed toward the fuel tank side. The insertion side spring 12 is fixed through a fixed end 12L wound like a coiled spring around a rotary axis 12S fitted to the path forming part 20. The insertion side spring 12 is fixed to the insertion side opening and closing member 11 at a free end opposite the fixed end 12L.

The insertion side spring 12 rotates in a range of predetermined angles about the rotary axis 12S around which the fixed end 12L is wound. The insertion side spring 12 biases the insertion side opening and closing member 11 in a direction of closing the filling opening 104 of the fuel path 100P. The insertion side spring 12 is arranged in such a manner that, when the filler neck 100 is installed on a vehicle in a tilted posture shown in FIG. 3, the fixed end 12L is located above the free end in the direction of gravitational force while the first valve mechanism 10 is closed. In other words, the insertion side spring 12 is arranged to be located above the axis OL in the direction of gravitational force. The outer body 21 includes a seal body 15 made of an oil-resistant rubber material formed around the filling opening 104. Thus, the insertion side opening and closing member 11 in a state of being biased by the insertion side spring 12 so as to close the filling opening 104 closes the filling opening 104 while the filling opening 104 is sealed by the seal body 15. When the filling nozzle FN is inserted, the filling nozzle FN contacts the insertion side opening and closing member 11 to apply force on the fuel tank side equal to or greater than the biasing force of the insertion side spring 12. This rotates the insertion side opening and closing member 11 toward the fuel tank side about the rotary axis 12S around which the fixed end 12L is wound in this way, the first valve mechanism 10 opens the filling opening 104.

The second valve mechanism 30 is arranged at the under body 23 of the path forming part 20 to he closer to the fuel tank side than the first valve mechanism 10. The second valve mechanism 30 opens and closes the insertion path 100Pn at the end of the insertion path 100Pn in the most upstream area of the fuel path 100P. The second valve mechanism 30 includes the fuel tank side opening and closing member 31 as a valve element for opening and closing the insertion path 100Pn, a fuel tank side spring 32 fixed to the path forming part 20 and biasing the fuel tank side opening and closing member 31 in a direction of closing the fuel tank side opening and closing member 31, and a pressure adjusting mechanism 33. The fuel tank side opening and closing member 31 is a flap valve that prevents backflow of liquid fuel from the fuel tank side toward the insertion side. The fuel tank side spring 32 is fixed through a fixed end 32L wound like a coiled spring around a rotary axis 32S fitted to the path forming part 20. The fuel tank side spring 32 is fixed to the fuel side opening and closing member 31 at a free end opposite the fixed end 32L. The fuel tank side spring 32 rotates in a range of predetermined angles about the rotary axis 32S around which the fixed end 32L is wound. The fuel tank side spring 32 biases the fuel tank side opening and closing member 31 in a direction of closing the insertion path 100Pn. The fuel tank side spring 32 is arranged in such a manner that, when the filler neck 100 is installed on a vehicle, the fixed end 32L is located above the free end in the direction of gravitational force while the second valve mechanism 30 is closed. In other words, like the insertion side spring 12 of the first valve mechanism 10, the fuel tank side spring 32 is arranged to be located above the axis OL in the direction of gravitational force.

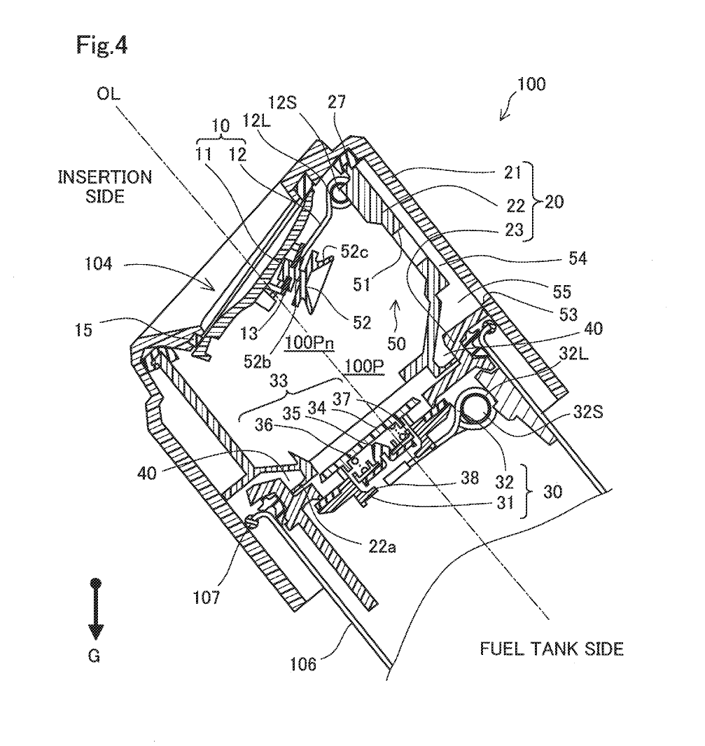

The pressure adjusting mechanism 33 mounted on the second valve mechanism 30 includes a spring mount 34, a valve element 35, and a spring 36. The spring 36 is mounted between the spring mount 34 and the valve element 35 integrated with the fuel tank side opening and closing member 31, and biases the valve element 35 toward the fuel tank side opening and closing member 31. In this way, in a normal state, the pressure adjusting mechanism 33 closes an opening 38 at the fuel tank side opening and closing member 31 using the valve element 35. FIG. 4 is an explanatory view showing a state of adjusting a positive pressure using the pressure adjusting mechanism 33 of the second valve mechanism 30.

The pressure state shown in FIG. 4 is what is called a positive pressure state in which, in a non-filling situation in which the first valve mechanism 10 closes the filling opening 104, pressure in the fuel path 100P downstream from the fuel tank side opening and closing member 31, specifically, tank inner pressure is higher than pressure in the insertion path 100Pn upstream from the fuel tank side opening and closing member 31. As shown in FIG. 4, in this positive pressure state, the valve element 35 receives the tank inner pressure to be separated from the fuel tank side opening and closing member 31, thereby opening the opening 38 at the fuel tank side opening and closing member 31. This encourages passage of air from the fuel path 100P downstream from the fuel tank side opening and closing member 31 into the insertion path 100Pn upstream from the fuel tank side opening and closing member 31 to make fuel gas (fuel vapor) having produced the positive pressure state enter the insertion path 100Pn. Then, the fuel gas is emitted to outside air through an insertion path communication hole 51 in an opened state described later and then through the outside air passage hole 53. This vapor emission reduces pressure in the fuel path 100P downstream from the fuel tank side opening and closing member 31 (tank inner pressure), thereby removing the positive pressure. In this embodiment, the biasing force of the spring 36 is adjusted to produce a positive pressure state in which tank inner pressure is higher by about 10% than average outside air pressure. In this state, the opening 38 is opened by the valve element 35, as described above.

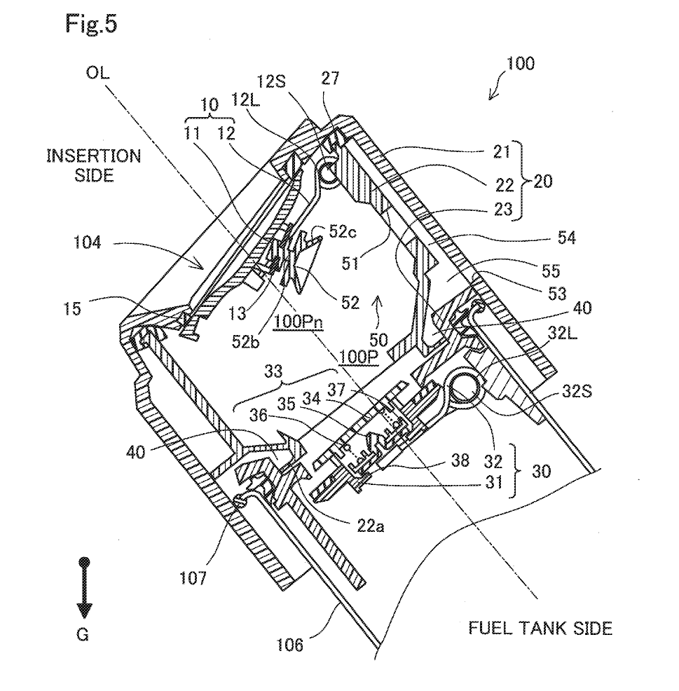

The biasing force of the fuel tank side spring 32 is adjusted to make the second valve mechanism 30 further fulfill a negative pressure adjusting function as follows. FIG. 5 is an explanatory view showing a state of adjusting a negative pressure using the second valve mechanism 30. The pressure state shown in FIG. 5 is what is called a negative pressure state in which, in the non-filling situation in which the first valve mechanism 10 closes the filling opening 104, pressure in the fuel path 100P downstream from the fuel tank side opening and closing member 31 (tank inner pressure) is lower than pressure in the insertion path 100Pn upstream from the fuel tank side opening and closing member 31. As shown in FIG. 5, in this negative pressure state, the fuel tank side opening and closing member 31 of the second valve mechanism 30 receives the pressure in the insertion path 100Pn upstream from the fuel tank side opening and closing member 31 to be slightly driven, thereby slightly opening the insertion path 100Pn. This makes air in the insertion path 100Pn enter the fuel path 100P downstream from the fuel tank side opening and closing member 31, specifically, enter the fuel tank FT (see FIG. 1) to increase the tank inner pressure having produced the negative pressure state. In this way, the negative pressure is removed. In this embodiment, the biasing force of the fuel tank side spring 32 is adjusted to produce a negative pressure state in which tank inner pressure is lower by about 10% than average outside air pressure. In this state, the second valve mechanism 30 is slightly driven, as described above.

The ventilation mechanism 50 is a valve mechanism for encouraging passage of outside air into the insertion path 100Pn. The ventilation mechanism 50 includes the insertion path communication hole 51, an on-off valve 52, the outside air passage hole 53, and a ventilation path 54. The insertion path communication hole 51 is formed at the inner body 22 at a position near the filling opening 104, and communicates with the insertion path 100Pn. While the path forming part 20 of the filler neck 100 is mounted in a tilted posture shown in FIG. 3 on the filling opening 104 (see FIG. 1), the insertion path communication hole 51 is located above the outside air passage hole 53 in the vertical direction. The insertion path communication hole 51 is formed on an extension line of a direction in which the first valve mechanism 10 moves during the foregoing operation of opening the first valve mechanism 10. Thus, the insertion path communication hole 51 is located at a position in the vertical direction above a maximum liquid level determined by blowing out of fuel in the filling period, thereby preventing overflow of the fuel. The outside air passage hole 53 is formed at the outer body 21 so as to allow entry of outside air through the outside air passage hole 53. As shown in FIG. 2, the outside air passage hole 53 is located at a position shifted from the insertion path communication hole 51 around the axis OL in the insertion path 100Pn. The ventilation path 54 is a gap between the outer body 21 and the inner body 22, and encourages passage of air between the insertion path communication hole 51 and the outside air passage hole 53. FIG. 3 shows the cross section taken along the bent lines 3-3 in FIG. 2, so that the ventilation path 54 in FIG. 3 is illustrated as a simple linear path. However, the insertion path communication hole 51 and the outside air passage hole 53 are shifted around the axis OL to form the ventilation path 54 into a shape such as a bent path or a labyrinth having a configuration in which projections from the inner wall surface of the outer body 21 and projections from the outer wall surface of the inner body 22 are aligned alternately, for example.

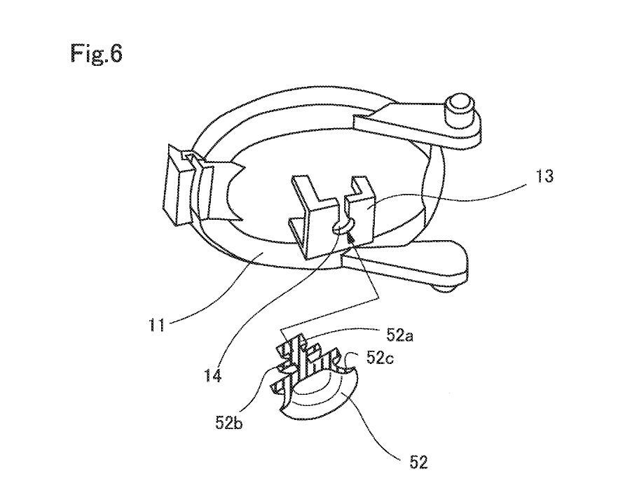

The on-off valve 52 is made of oil-resistant elastic rubber such as nitrile rubber, butyl rubber, or silicone rubber, for example. As shown in FIG. 3, the on-off valve 52 is fitted as a part of the insertion side opening and closing member 11 of the first valve mechanism 10. FIG. 6 is an explanatory view briefly showing fitting of the on-off valve 52. The on-off valve 52 includes a fitting projection 52a formed at the top, a horn-like valve tip 52c, and a shaft 52b supporting the valve tip 52c. The on-off valve 52 is fitted as a part of the insertion side opening and closing member 11 in such a manner that the fitting projection 52a is inserted into an insertion hole 14 at a fitting bridge 13 provided at the insertion side opening and closing member 11 and functioning as a valve support member. The on-off valve 52 fitted in this way makes the valve tip 52c and the shaft 52b extending from the fitting projection 52a function as an elastic deflection part of the present disclosure. In a period of not filling fuel shown in FIG. 3, specifically, while the first valve mechanism 10 closes the filling opening 104, the on-off valve 52 opens the insertion path communication hole 51.

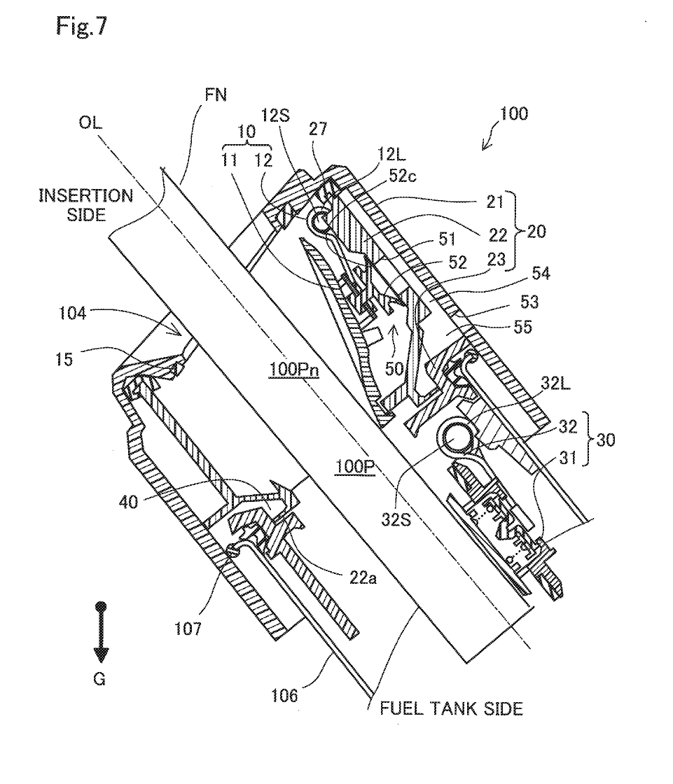

FIG. 7 is an explanatory view showing a state in which the ventilation mechanism 50 closes the insertion path communication hole 51 in a fuel filling period. As described above, the on-off valve 52 of the ventilation mechanism 50 opens the insertion path communication hole 51 in the situation of not filling fuel shown in FIG. 3. By contrast, in the fuel-filling period (filling situation), the filling nozzle FN is inserted through the filling opening 104 as shown in FIG. 7. The inserted filling nozzle FN drives the insertion side opening and closing member 11 of the first valve mechanism 10 so as to open the filling opening 104. Then, the on-off valve 52 of the ventilation mechanism 50 closes the insertion path communication hole 51 with the valve tip 52c supported by the shaft 52b. Specifically, the on-off valve 52 is driven in conjunction with the operation for opening and closing the filling opening 104 by the first valve mechanism 10 to close the insertion path communication hole 51, thereby interrupting passage of air between the insertion path communication hole 51 and the outside air passage hole 53. This will be described in relation to the non-filling period. The on-off valve 52 opens and closes the insertion path communication hole 51. with the shaft 52b and the valve tip 52c functioning as the elastic deflection part.

In the foregoing filler neck 100 functioning as the opening and closing device for a fuel tank of this embodiment, in the non-filling situation in which the first valve mechanism 10 closes the filling opening 104, the on-off valve 52 of the ventilation mechanism 50 opens the insertion path communication hole 51 communicating with the insertion path 100Pn, as shown in FIG. 3. This allows the filler neck 100 to ensure air permeability in the insertion path 100Pn in the non-filling situation. In the filler neck 100, when the first valve mechanism 10 opens the filling opening 104 in the fuel filling situation, the insertion path communication hole 51 communicating with the insertion path 100Pn is closed by the on-off valve 52 driven in conjunction with the insertion side opening and closing member 11 of the first valve mechanism 10. Further, in response to insertion of the filling nozzle FN, the second valve mechanism 30 opens the insertion path 100Pn at the end of the insertion path 100Pn. In the fuel filling situation, liquid fuel supplied from the filling nozzle FN may overflow into the insertion path 100Pn. In this state, the on-off valve 52 closes the insertion path communication hole 51 communicating with the insertion path 100Pn, so that the overflowing liquid fuel once stays in the insertion path 100Pn and then flows from the insertion path 100Pn into the fuel path 100P downstream from the insertion path 100Pn. In this way, the filler neck 100 is allowed to prevent discharge of the liquid fuel to the outside through the insertion path communication hole 51 in the fuel filling period. Further, in the filler neck 100, the insertion path communication hole 51 is opened and closed by the on-off valve 52 to be driven in conjunction with the insertion side opening and closing member 11 of the first valve mechanism 10. Thus, opening and closing the insertion path communication hole 51 requires only the rotary axis 12S at the fixed end 12L, contributing to simplification of the configuration.

In the filler neck 100 of this embodiment, the on-off valve 52 is made of an oil-resistant rubber material to make the shaft 52b and the horn-like valve tip 52c supported by the shaft 52b function as the elastic deflection part. The deflections of the shapes of these parts are used for absorbing variations in the position of the on-off valve 52 to allow the insertion path communication hole 51 to be closed preferably with high accuracy. This effectively reduces discharge of liquid fluid to the outside. Even if the on-off valve 52 becomes incapable of deflecting sufficiently due to the deterioration of the rubber material, for example, to prohibit the on-off valve 52 from closing the insertion path communication hole 51 completely; the deformations by deflections of the shapes of the shaft 52b and the valve tip 52c still function to reduce a degree of discharge of the liquid fluid to the outside.

While the path forming part 20 is mounted in the filling room FR as shown in FIG. 1, the filler neck 100 of this embodiment assumes a tilted posture as shown in FIG. 3. In this state, in the filler neck 100, the insertion path communication hole 51 is located above the outside air passage hole 53 in the vertical direction. By doing so, in the filler neck 100 of this embodiment, a gap from the second valve mechanism 30 at the end of the insertion path 100Pn to the insertion path communication hole 51 is increased. Thus, even if liquid fuel overflows in large quantities into the insertion path 100Pn in the fuel filling period, the overflowing liquid fuel is still prevented from being discharged to the outside through the insertion path communication hole 51 reliably, or discharge of the overflowing liquid is reduced.

In the filler neck 100 of this embodiment, the inner body 22 has the insertion path communication hole 51, and the outer body 21 has the outside air passage hole 53 communicating with the insertion path communication hole 51 through the ventilation path 54. Further, the outside air passage hole 53 is located at a position shifted from the insertion path communication hole 51 around the axis OL in the insertion path 100Pn. Thus, in the filler neck 100 of this embodiment, the ventilation path 54 for encouraging passage of air between the insertion path communication hole 51 and the outside air passage hole 53 is allowed to be formed into a bent path or a labyrinth configuration. This makes it possible to reduce mixture of impurities such as dust or dirt during passage of air into the insertion path 100Pn in the non-filling period, and further reduce entry of water during vehicle wash under high pressure, for example.

In the filler neck 100 of this embodiment, the on-off valve 52 for opening and closing the insertion path communication hole 51 is fitted as a part of the insertion side opening and closing member 11 of the first valve mechanism 10. This allows the insertion path communication hole 51 to be closed directly and simply by the driving of the insertion side opening and closing member 11 for opening the filling opening 104.

### B. Second Embodiment

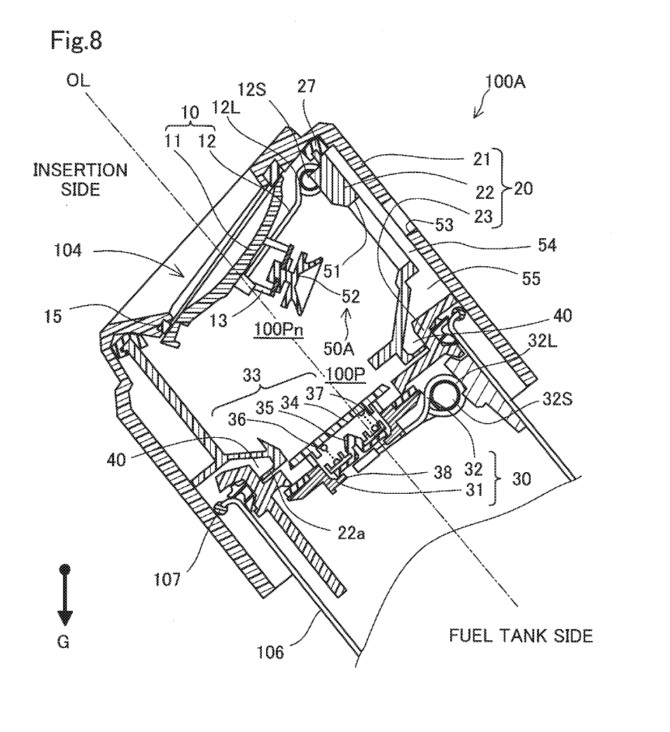

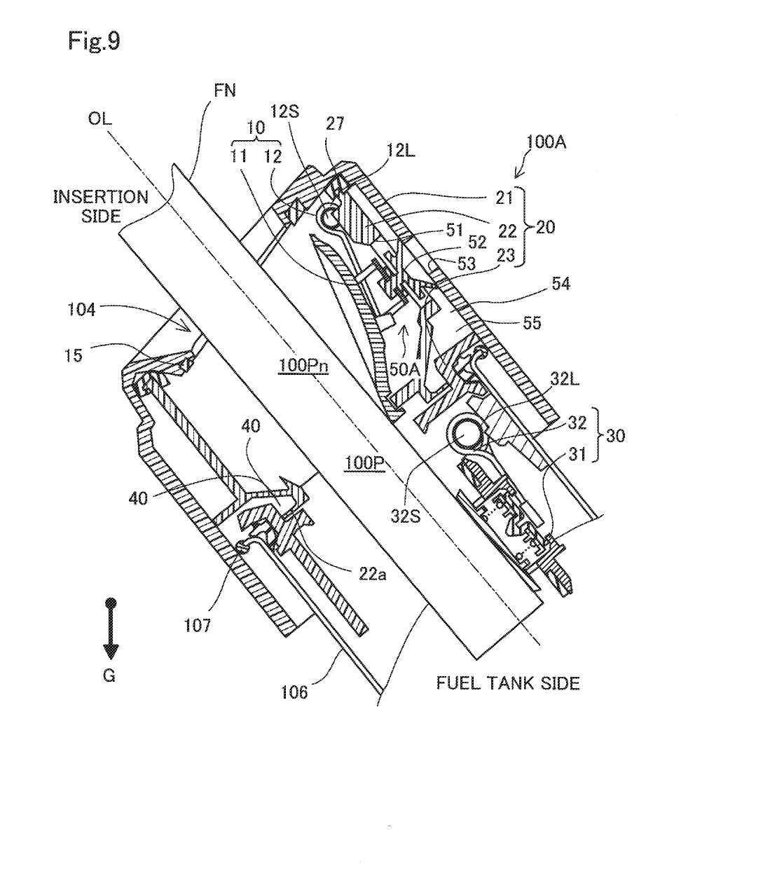

FIG. 8 is an explanatory view showing a principal part of a filler neck 100A in a cross section according to a second embodiment taken along lines simulating the bent lines 3-3 in FIG. 2. FIG. 9 is an explanatory view showing a state in which a ventilation mechanism 50A of the filler neck 100A according to the second embodiment closes the outside air passage hole 53 in the fuel filling period. The filler neck 100A of the second embodiment differs from the foregoing filler neck 100 of the first embodiment in that the on-off valve 52 opens and closes the outside air passage hole 53. In the following description, a part having the same function as a corresponding part of the first embodiment will be given the same sign, even if these parts are different in shape, etc.

As shown in FIG. 8, in the filler neck 100A of the second embodiment, the outside air passage hole 53 is a through hole having a smaller diameter than the insertion path communication hole 51, and the outside air passage hole 53 is formed at the outer body 21 along the axis of the insertion path communication hole 51. In this embodiment, the respective axes of the outside air passage hole 53 and the insertion path communication hole 51 are arranged concentrically. Alternatively, as long as the on-off valve 52 is capable of opening and closing the outside air passage hole 53 as described later, these axes may be arranged at shifted positions. The filler neck 100A includes the fitting bridge 13 longer than the fitting bridge 13 of the filler neck 100 of the first embodiment, and the on-off valve 52 fitted to the fitting bridge 13 has a size that allows the on-off valve 52 to pass through the insertion path communication hole 51. Further, the on-off valve 52 is driven in conjunction with the operation for opening and closing the filling opening 104 by the first valve mechanism 10. In the filling situation, the on-off valve 52 passes through the insertion path communication hole 51 to close the outside air passage hole 53. In the non-filling situation, the on-off valve 52 opens the insertion path communication hole 51 and the outside air passage hole 53.

Like the foregoing filler neck 100 of the first embodiment, the filler neck 100A functioning as an opening and closing device for a fuel tank of the second embodiment is capable of preventing or reducing discharge of liquid fuel to the outside in the fuel filling period while ensuring air permeability in the insertion path 100Pn in the non-filling situation.

### C. Third Embodiment

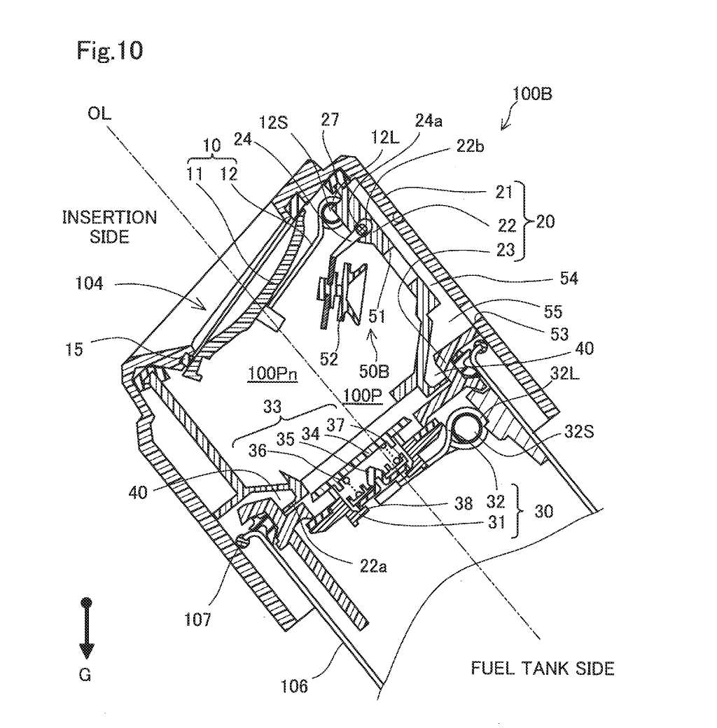

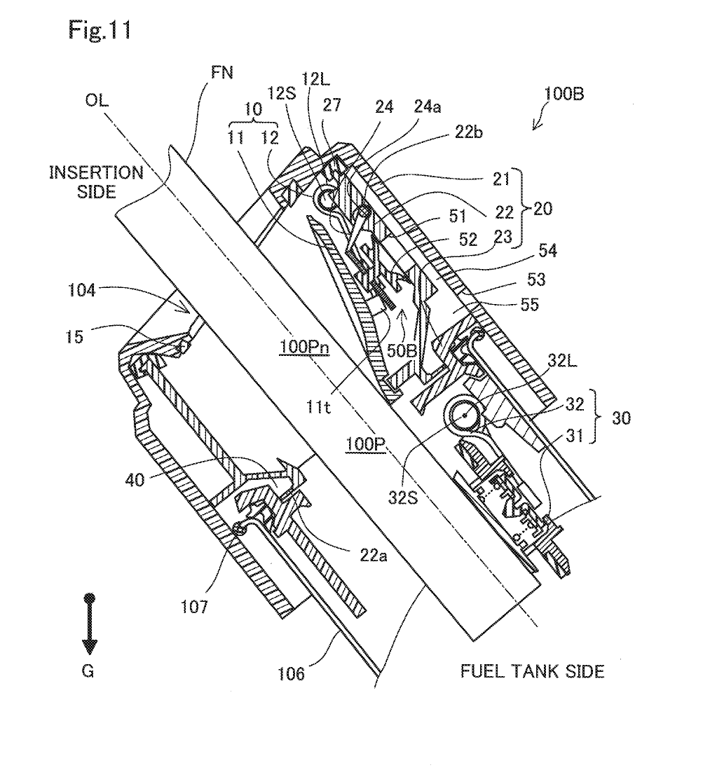

FIG. 10 is an explanatory view showing a principal part of a filler neck 100B in a cross section according to a third embodiment taken along lines simulating the bent lines 3-3 in FIG. 2. FIG. 11 is an explanatory view showing a state in which a ventilation mechanism 50B of the filler neck 100B according to the third embodiment closes the insertion path communication hole 51 in the fuel filling period. The filler neck 100B of the third embodiment differs from the foregoing filler neck 100 of the first embodiment in that the on-off valve 52 is fitted as a part of the inner body 22.

As shown in FIG. 10, the filler neck 100B of the third embodiment includes a rotary axis 24a of an arm plate 24 functioning as a valve support member mounted in a long hole 22b at the inner peripheral wall of the inner body 22. The on-off valve 52 is supported by the arm plate 24. The arm plate 24 is rotatable around the rotary axis 24a in the long hole 22a as a place for mounting at the body inner peripheral wall. Further, the arm plate 24 is biased by a coiled spring not shown in the drawings so as to separate the on-off valve 52 from the insertion path communication hole 51. The long hole 22b is formed in such a manner that the long axis of the long hole 22b extends parallel to the axis of the insertion path communication hole 51. The first valve mechanism 10 is configured in such a manner that, in response to opening of the filling opening 104 using the insertion side opening and closing member 11 in the fuel filling situation, the on-off valve 52 is pressed together with the arm plate 24 toward the insertion path communication hole 51 with a back projection lit of the insertion side opening and closing member 11, as shown in FIG. 11. In this way, the on-off valve 52 closes the insertion path communication hole 51. The back projection lit is a projection fulfilling the function of holding the insertion side spring 12.

Like the foregoing filler neck 100 of the first embodiment, the filler neck 100B functioning as an opening and closing device for a fuel tank of the third embodiment is capable of preventing or reducing discharge of liquid fuel to the outside in the fuel filling period while ensuring air permeability in the insertion path 100Pn in the non-filling period.

In the filler neck 100B of the third embodiment, the arm plate 24 holding the on-off valve 52 is rotatable in the long hole 22b as a place for mounting the arm plate 24. Thus, in the filler neck 100B, the rotation of the arm plate 24 becomes available for ensuring a closed state of the insertion path communication hole 51 produced by the on-off valve 52 fitted as a part of the inner body 22. This increases the accuracy of each part such as the insertion side opening and closing member 11 or a degree of freedom in assembly clearance of each part, thereby achieving reduction in manufacturing cost and cost of assembly adjustment. Additionally, the arm plate 24 rotates while the rotary axis 24a moves along the long hole 22b and parallel to the axis of the insertion path communication hole 51. This provides uniformity to a closed state of the insertion path communication hole 51 (sealing performance) produced by the on-off valve 52.

### D. Fourth Embodiment

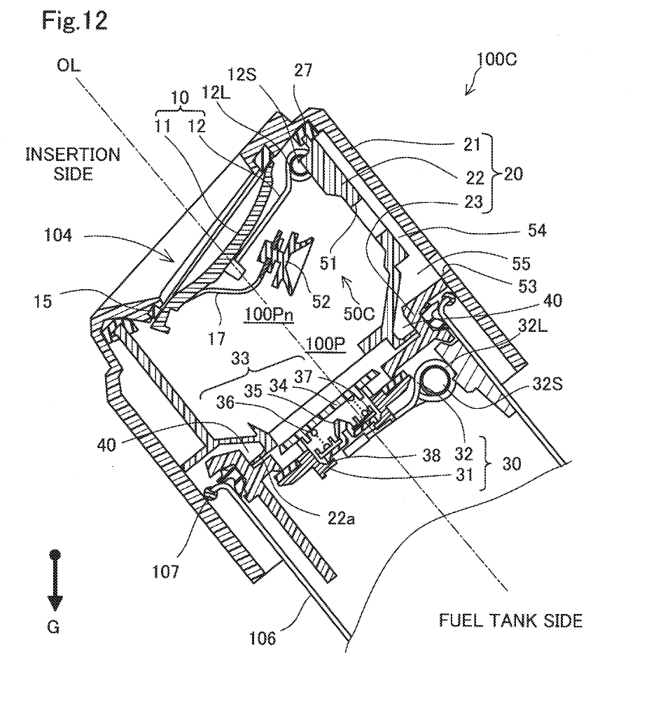

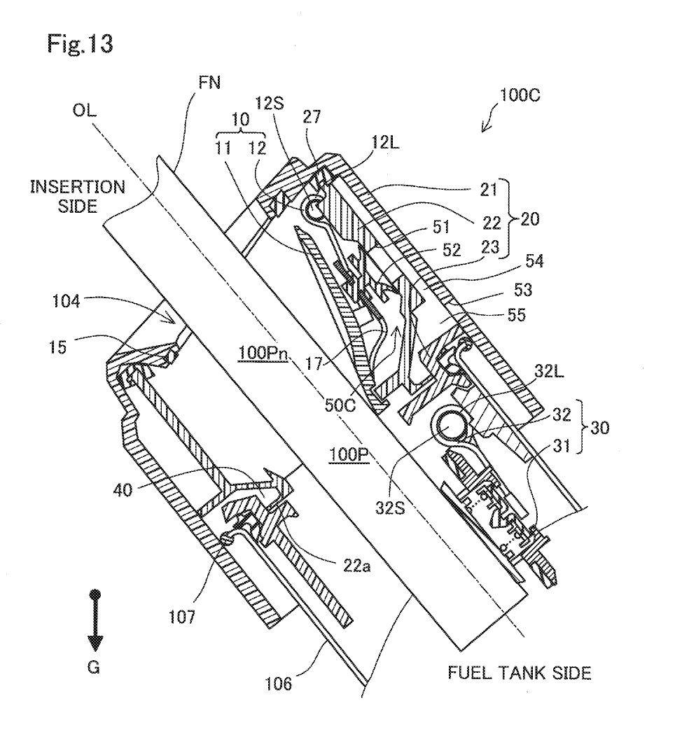

FIG. 12 is an explanatory view showing a principal part of a filler neck 100C in a cross section according to a fourth embodiment taken along lines simulating the bent lines 3-3 in FIG. 2. FIG. 13 is an explanatory view showing a state in which a ventilation mechanism 50C of the filler neck 100C according to the fourth embodiment closes the insertion path communication hole 51 in the fuel filling period. The filler neck 100C of the fourth embodiment differs from the foregoing filler neck 100 of the first embodiment in that the on-off valve 52 is fitted as a part of the insertion side opening and closing member 11 by a spring plate 17 functioning as a valve support member.

As shown in FIG. 12, the filler neck 100C of the fourth embodiment includes the spring plate 17 mounted on the back side of the insertion side opening and closing member 11. The on-off valve 52 is held by the spring plate 17. The spring plate 17 is made of a spring steel sheet formed into a bent shape, and has flexibility by which the bent shape is stretched, thereby exhibiting elasticity. As shown in FIG. 13, in response to opening of the filling opening 104 using the insertion side opening and closing member 11 in the fuel filling period, the first valve mechanism 10 presses the on-off valve 52 together with the spring plate 17 toward the insertion path communication hole 51. During this press, the spring plate 17 deflects. In this way, the on-off valve 52 closes the insertion path communication hole 51.

Like the foregoing filler neck 100 of the first embodiment, the filler neck 100C functioning as an opening and closing device for a fuel tank of the fourth embodiment is capable of preventing or reducing discharge of liquid fuel to the outside in the fuel filling period while ensuring air permeability in the insertion path 100Pn in the non-filling period.

In the filler neck 100C of the fourth embodiment, the on-off valve 52 is held by the spring plate 17 having flexibility. Thus, in the filler neck 100C, the deflection of the spring plate 17 becomes available for ensuring a closed state of the insertion path communication hole 51 produced by the on-off valve 52 fitted as a part of the insertion side opening and closing member 11. This increases the accuracy of each part such as the insertion side opening and closing member 11 or a degree of freedom in assembly clearance of each part, thereby achieving reduction in manufacturing cost and cost of assembly adjustment.

### E. Fifth Embodiment

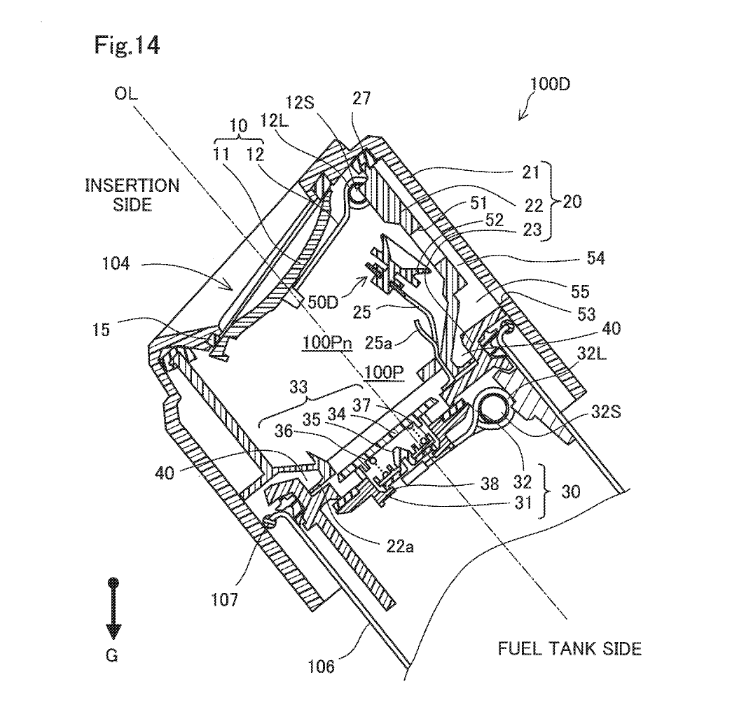

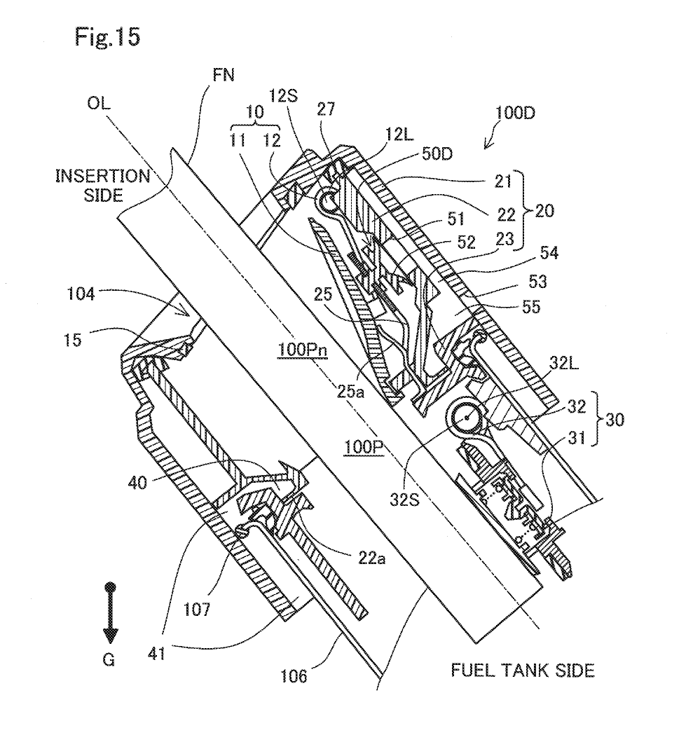

FIG. 14 is an explanatory view showing a principal part of a filler neck 100D in a cross section according to a fifth embodiment taken along lines simulating the bent lines 3-3 in FIG. 2. FIG. 15 is an explanatory view showing a state in which a ventilation mechanism 50D of the filler neck 100D according to the fifth embodiment closes the insertion path communication hole 51 in the fuel filling period. The filler neck 100D of the fifth embodiment differs from the foregoing filler neck 100 of the first embodiment in that the on-off valve 52 is fitted as a part of the inner body 22.

As shown in FIG. 14, in the filler neck 100D of the fifth embodiment, the on-off valve 52 is held at the inner body 22 by a spring plate 25 functioning as a valve support member so as to face the insertion path communication hole 51. The spring plate 25 is made of a spring steel sheet formed into a bent shape, and has flexibility by which the bent shape is stretched, thereby exhibiting elasticity. Further, the spring plate 25 is fixed to the under body 23 at the base of the spring plate 25, and extends while penetrating the inner body 22. The spring plate 25 has an arm 25a that receives pressing force from the insertion side opening and closing member 11. As shown in FIG. 15, in response to opening of the filling opening 104 using the insertion side opening and closing member 11 in the fuel filling period, the first valve mechanism 10 presses the on-off valve 52 together with the spring plate 25 toward the insertion path communication hole 51. During this press, the spring plate 25 receives the pressing force through the arm 25a to deflect. In this way, the on-off valve 52 closes the insertion path communication hole 51.

Like the foregoing filler neck 100 of the first embodiment, the filler neck 100D functioning as an opening and closing device for a fuel tank of the fifth embodiment is capable of preventing or reducing discharge of liquid fuel to the outside in the fuel filling period while ensuring air permeability in the insertion path 100Pn in the non-filling period.

In the filler neck 100D of the fifth embodiment, the on-off valve 52 is held by the spring plate 25 having flexibility. Thus, in the filler neck 100D, the deflection of the spring plate 25 becomes available for ensuring a closed state of the insertion path communication hole 51 produced by the on-off valve 52 fitted as a part of the inner body 22. This increases the accuracy of each part such as the insertion side opening and closing member 11 or a degree of freedom in assembly clearance of each part, thereby achieving reduction in manufacturing cost and cost of assembly adjustment.

### F. Sixth Embodiment

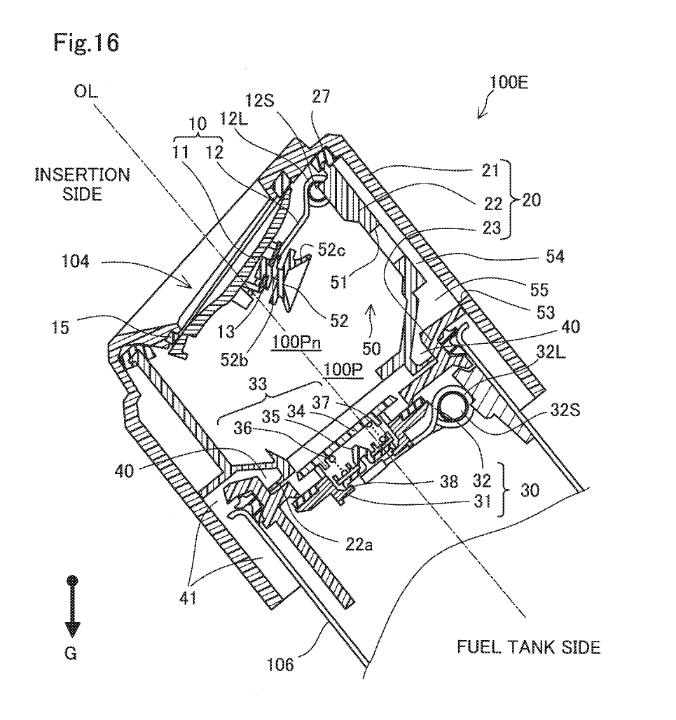

FIG. 16 is an explanatory view showing a principal part of a filler neck 100E in a cross section according to a sixth embodiment taken along lines simulating the bent lines 3-3 in FIG. 2. The filler neck 100E of the sixth embodiment differs from the foregoing filler neck 100 of the first embodiment in that the liquid-tight region 40 is opened to outside air at a place other than the outside air passage hole 53.

In the filler neck 100E of the sixth embodiment, the seal piece 22a forms the liquid-tight region 40 between the inner body 22 and the outer body 21, and the liquid-tight region 40 surrounds the fuel tank side opening and closing member 31 of the second valve mechanism 30 in a liquid-tight manner from a side of the insertion path 100Pn, as described above. Further, the liquid-tight region 40 communicates with the outside air passage hole 53 at the outer body 21 through the communication part 55. While the path forming part 20 is mounted in the filling room FR (see FIG. 1), the liquid-tight region 40 is opened to outside air through an opening part 41 at a low-level position in the vertical direction. Thus, the filler neck 100E of this embodiment is capable of discharging water having entered through the outside air passage hole 53 during vehicle wash through injection of high-pressure water by guiding the water into the liquid-tight region 40, causing the water to stay in the liquid-tight region 40, and then discharging the water through the opening part 41 to the outside of the vehicle.

The present disclosure is not limited to the above-described embodiments, examples, or modifications but is feasible in various configurations within a range not deviating from the substance of the invention. For example, technical features in the embodiments, those in the examples, or those in the modifications corresponding to technical features in each aspect described in SUMMARY may be replaced or combined, where appropriate, with the intention of solving some or all of the foregoing problems or achieving some or all of the foregoing effects. Unless being described as absolute necessities in this specification, these technical features may be deleted, where appropriate.

In each of the filler necks 100 to 100E of the corresponding embodiments described above, the on-off valve 52 has a horn-like shape. Alternatively, the on-off valve 52 may be an on-off valve made of an oil-resistant rubber material formed into a flat-plate shape.

In the foregoing embodiments, the second valve mechanism 30 has the positive pressure adjusting function fulfilled by the pressure adjusting mechanism 33, and the negative pressure adjusting function fulfilled through adjustment of the biasing force of the fuel tank side spring 32. Alternatively, the second valve mechanism 30 may function only to open and close the insertion path 100Pn. Still alternatively, the second valve mechanism 30 may have either the positive pressure adjusting function or the negative pressure adjusting function.

In the foregoing embodiments, while the path forming part 20 is mounted in the filling room FR, the insertion path communication hole 51 is located above the outside air passage hole 53 in the vertical direction. Alternatively, the insertion path communication hole 51 may be located below the outside air passage hole 53 in the vertical direction.

In the foregoing embodiments, the outside air passage hole 53 is located at a position shifted from the insertion path communication hole 51 around, the axis OL in the insertion path 100Pn. Alternatively, the outside air passage hole 53 may be aligned with the insertion path communication hole 51 along the axis OL in the insertion path 100Pn.

In the foregoing embodiments, the on-off valve 52 is provided at the insertion side opening and closing member 11 of the first valve mechanism 10 or the inner body 22 of the path forming part 20. Alternatively, the on-off valve 52 may be held by a telescopic support member extending from the inner wall of the outer body 21 and penetrating the insertion path communication hole 51.

What is claimed is:

1. An opening and closing device for a fuel tank, comprising:
a path forming part that forms a fuel path along which supplied liquid fuel is guided to the fuel tank;
a first valve mechanism arranged at the path forming par opening and closing a filling opening of the fuel path;
a second valve mechanism arranged at the path forming part to be closer to a fuel tank side than the first valve mechanism, the second valve mechanism opening and closing an insertion path for a fuel nozzle at the end of the insertion path in the most upstream area of the fuel path using an opening and closing member; and
a ventilation mechanism that encourages passage of outside air into the insertion path, wherein
the path forming part includes:
an insertion path forming part that defines the insertion path in the most upstream area of the fuel path, and forms an insertion path communication hole communicating with the insertion path on an extension line of a direction in which the first valve mechanism moves during operation of opening the first valve mechanism; and
a surrounding part that surrounds the insertion path forming part from outside with a gap left between the surrounding part and the insertion path forming part, and includes an outside air passage hole formed to make the gap communicate with outside air,
in a non-filling situation in which the first valve mechanism closes the filling opening, the ventilation mechanism encourages passage of air between the insertion path communication hole and the outside air passage hole through the gap, and
in a filling situation in which the fuel nozzle makes the first valve mechanism open the filling opening, the ventilation mechanism interrupts passage of air between the insertion path communication hole and the outside air passage hole.

2. The opening and closing device for a fuel tank in accordance with claim 1, wherein
the second valve mechanism includes a pressure adjusting mechanism provided at the opening and closing member, and
in the non-filling situation, if pressure in the fuel path downstream from the opening and closing member is higher than pressure in the insertion path upstream from the opening and closing member, the pressure adjusting mechanism encourages passage of air from the fuel path downstream from the opening and closing member into the insertion path.

3. The opening and closing device for a fuel tank in accordance with c claim 1, wherein
in the non-filling situation, if pressure in the fuel path downstream from the opening and closing member becomes lower than pressure in the insertion path upstream from the opening and closing member, the second valve mechanism drives the opening and closing member so as to open the insertion path.

4. The opening and closing device for a fuel tank in accordance with claim 1, wherein
the ventilation mechanism includes an on-off valve to be driven in conjunction with operation for opening and closing the filling opening by the first valve mechanism, and
the on-off valve closes the insertion path communication hole in the falling situation, and opens the insertion path communication hole in the non-filling situation.

5. The opening and closing device for a fuel tank in accordance with claim 4, wherein
the on-off valve includes an elastic deflection part, and opens and closes the insertion path communication hole with the elastic deflection part.

6. The opening and closing device for a fuel tank in accordance with claim 4, wherein
the on-off valve of the ventilation mechanism is fitted as a part of at least one of the first valve mechanism and the insertion path forming part.

7. The opening and closing device for a fuel tank in accordance with claim 6, wherein
the on-off valve of the ventilation mechanism is fitted as a part of the first valve mechanism by being held by a valve support member.

8. The opening and closing device for a fuel tank in accordance with claim 7, wherein
the valve support member has elasticity.

9. The opening and closing device for a fuel tank in accordance with claim 6, wherein
the on-off valve of the ventilation mechanism is fitted as a part of the insertion path forming part by being held by a valve support member.

10. The opening and closing device for a fuel tank in accordance with claim 9, wherein
the valve support member has elasticity.

11. The opening and closing device for a fuel tank in accordance with claim 1, wherein
while the path forming part is mounted in a filling room, the insertion path communication hole is located above the outside air passage hole in the vertical direction.

12. The opening and closing device for a fuel tank in accordance with claim 1, wherein
the outside air passage hole is located at a position shifted from the insertion path communication hole around an axis in the insertion path.

13. The opening and closing device for a fuel tank in accordance with claim 1, wherein
the insertion path forming part forms a liquid-tight region between the insertion path forming part and the surrounding part, the liquid-tight region surrounding the opening and closing member of the second valve mechanism in a liquid-tight manner from a side of the insertion path, and
the surrounding part includes the outside air passage hole communicating with the liquid-tight region, and an opening part through which the liquid-tight region is opened to outside air at a low-level position in the vertical direction while the path forming part is mounted in a filling room.

14. The opening and closing device for a fuel tank in accordance with claim 1, wherein
the outside air passage hole has a smaller diameter than the insertion path communication hole, and is formed at the surrounding part along the axis of the insertion path communication hole,
the ventilation mechanism includes an on-off valve to be driven in conjunction with operation for opening and closing the filling opening by the first valve mechanism and having a size that allows the on-off valve to pass through the insertion path communication hole, and
in the filling situation, the on-off valve passes through the insertion path communication hole to close the outside air passage hole, and in the non-filling situation, the on-off valve opens the insertion path communication hole and the outside air passage hole.

15. The opening and closing device for a fuel tank in accordance with claim 14, wherein
the on-off valve of the ventilation mechanism is fitted as a part of at least one of the first valve mechanism and the insertion path forming part.

16. The opening and closing device for a fuel tank in accordance with claim 15, wherein
the on-off valve of the ventilation mechanism is fitted as a part of the first valve mechanism by being held by a valve support member.

17. The opening and closing device for a fuel tank in accordance with claim 16, wherein
the valve support member has elasticity.

18. The opening and closing device for a fuel tank in accordance with claim 15, wherein
the on-off valve of the ventilation mechanism is fitted as a part of the insertion path forming part by being held by a valve support member.

19. The opening and closing device for a fuel tank in accordance with claim 18, wherein
the valve support member has elasticity.
